(19) United States
(12) Patent Application Publication
(10) Pub. No.: US 2014/0172680 A1
(43) Pub. Date: Jun. 19, 2014

(54) SYSTEM AND METHOD FOR ACQUIRING AND ADMINISTERING SMALL BUSINESS MERCHANT ACCOUNTS

(71) Applicant: Rajen S. Prabhu, East Meadows (SG)

(72) Inventor: Rajen S. Prabhu, East Meadows (SG)

(21) Appl. No.: 13/720,564

(22) Filed: Dec. 19, 2012

(51) Int. Cl. G06Q 40/02

(52) U.S. Cl. CPC G06Q 40/025
USPC 705/38

(57) ABSTRACT

A method for verifying financial credential, issuing a payment card, and creating a merchant services account includes receiving a prospective account holder payment card application and a set of financial credentials, comparing, by an underwriting element, the financial credentials to a predetermined standard for issuing a payment card, receiving an indication of applying for a merchant services account, confirming, by an evaluation element, that the financial credentials meet one or more predetermined merchant services account standards, if the financial credentials meet the predetermined standards for issuing the payment card, issuing the payment card, and if the financial credentials meet the one or more standards for a merchant services account, creating the merchant services account for the prospective account holder. A system having components for implementing the method and a computer readable medium are also disclosed.

### BACKGROUND

Banking relationships are increasingly important to small businesses. Most small businesses require one or more bank accounts to operate. An increasing number of small businesses also desire a banking relationship which allows the business to obtain a payment card associated with a business bank account (such as a debit card). Often, financial institutions require that small businesses go through some underwriting or analysis in order to qualify for or obtain a business debit card. Approval for such a payment card provides great convenience and benefits to a small business.

Many small businesses that take payments from their customers also wish to obtain a merchant account which allows the business to accept payments by credit, prepaid, debit or charge cards. To obtain a merchant account, the small business must go through a separate underwriting and approval process, often with a different financial institution. Approval for a merchant account can be a time consuming and paperwork intensive process. Depending on the region where the small business is located, the underwriting, analysis and verification of information could require site visits to the business, verification of financial statements, and the need to obtain professional, personal and/or banking references.

### SUMMARY

A system and method for acquiring and administering small business merchant accounts is provided which includes receiving a prospective account holder payment card application and a set of financial credentials, comparing, by an underwriting element, the financial credentials to a predetermined standard for issuing a payment card, receiving an indication of applying for a merchant services account, confirming, by an evaluation element, that the financial credentials meet one or more predetermined merchant services account standards set by an issuer, if the financial credentials meet the predetermined standards for issuing the payment card, issuing the payment card, and if the financial credentials meet the one or more standards for a merchant services account, creating the merchant services account for the prospective account holder. A system having components for implementing the method and a computer readable medium are also disclosed.

Embodiments provide an efficient, secure and cost effective process for underwriting and issuing both a payment card and a merchant account to a prospective account holder.

With these and other advantages and features of the invention that will become hereinafter apparent, the invention may be more clearly understood by reference to the following detailed description of the invention, the appended claims, and the drawings attached hereto.

### BRIEF DESCRIPTION OF THE DRAWINGS

FIG. 1 depicts a system in accordance with some embodiments of the present invention;

FIG. 2 depicts a system in accordance with further embodiments of the present invention.

FIG. 3 depicts an MPOS system server in accordance with some embodiments of the present invention; and

FIG. 4 depicts a process in accordance with some embodiments of the present invention.

### DETAILED DESCRIPTION

Systems and methods embodying the present invention can result in the issuance of both a payment card account and a merchant account to a small business in a single underwriting and issuance process.

For convenience and ease of exposition, a number of terms are used herein. As used herein, the term “payment card” is used to refer to a transaction instrument issued to a small business for use in accessing an account at an issuing financial institution (the “issuer”). In general, pursuant to some embodiments, the transaction instrument is likely a debit card allowing debit access to a demand deposit account at an issuer. However, embodiments may be used with other types of payment cards, such as credit cards or the like. Further, the term “payment card” is not limited to specific form factors of payment cards (e.g., the use of the term “card” does not necessarily imply or require that the payment card be issued as a plastic card, but can also refer to payment cards issued as other form factors).

As used herein, the term “merchant account” refers to a account or relationship which allows a business to accept credit card, debit card, or other payment cards for payment. Pursuant to some embodiments, the issuer of the payment card may also act as the processor or acquirer of the merchant account. Further, the issuer also acts as the independent sales organization (“ISO”) associated with the merchant account.

As used herein, the term “Mobile as Point of Sale” or “MPOS” is used to refer to a system operated by an entity to facilitate transactions involving the merchant account. The entity may be different than the issuer, and may be associated with a payment association or payment network, such as those provided by the assignee of the present application, MasterCard International Incorporated.

As used herein, the term “merchant” will be used to refer to a business, such as a small business, which wishes to obtain a business bank account and payment card from an issuing financial institution as well as a merchant account to accept electronic payments from its customers.

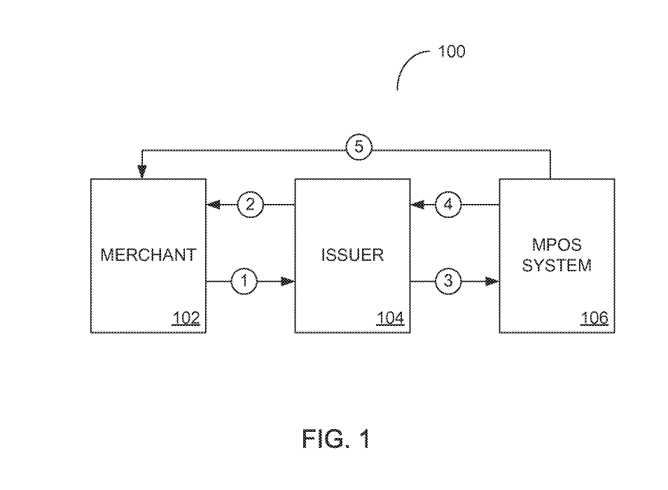

Features of some embodiments will now be described by reference to FIG. 1, where some components of a system 100 are shown. As depicted, system 100 includes a merchant 102, an issuer 104 and an MPOS system 106 which interact to issue a payment account (including an access device such as a debit card) and a merchant account (as well as one or more mobile point of sale devices) to a merchant 102. The merchant 102 may have a banking relationship (such as a business checking or other bank account) with issuer 104. Pursuant to some embodiments, both the payment account and the merchant account are issued based on a single application process by the merchant, providing a convenient and efficient experience for the merchant. Further, embodiments allow the issuer 104 to act as both the issuer of the payment account and the merchant account.

As illustrated in FIG. 1, the system 100 may be used in a process to issue a payment card and a merchant account to a merchant 102. The process begins at “1” with the merchant 102 interacting with the issuer 104 to complete an application for a business debit card. The application may include a number of items of information associated with the merchant which allow the issuer 104 to analyze whether a payment account (and associated debit card or other access device) may be issued to the merchant 102. The information may include information identifying: the merchant name, a business registration or tax identifier, a business category (e.g., such as a SIC code or the like), a business address, one or more phone numbers, authorized signatory details, account details, and other contact information (including an email address, etc.). The merchant 102 may provide this information to the issuer 104 via interaction over the Internet (e.g., by providing the data over one or more Web pages), via telephone, via post, in person at a branch location of the issuer 104, or the like.

Upon receipt of the application information, the issuer 104 may perform an analysis of the information using a risk assessment module or component. The risk assessment module or component may be configured to perform an analytic risk assessment on the merchant 102 by comparing the information received with a predetermined standard for evaluating the creditworthiness of the merchant to receive a payment card. If the issuer 104 determines that the merchant 102 is eligible to receive the payment card and associated payment account (e.g., the issuer 104 determines the merchant 102 is approved to receive a debit card), the issuer 104 may perform additional processing to determine whether the merchant 102 is also eligible to be approved for a merchant account. Pursuant to some embodiments, the application information received at “1” is also used by the issuer 104 to perform a risk and underwriting analysis of whether the merchant 102 is eligible to be approved for a merchant account. The result of the risk and underwriting analysis may include a approval as well as information defining the criteria or limitations associated with a merchant account for the merchant 102. For example, the risk and underwriting analysis may result in a merchant 102 being approved for a merchant account with a daily transaction volume limit, a monthly fee amount, a transaction fee amount, and other account limitations.

Once a merchant's application information has been analyzed and the merchant 102 has been approved for a payment account as well as a merchant account, the issuer 104 transmits (at “2”) a confirmation to the merchant 102. The confirmation may include details of the payment account, and may also include providing the merchant 102 with an access device (such as a plastic card) for use in accessing the payment account. The issuer 104 also provides (at “3”) information to a processing system (shown and referred to in FIG. 1 as the “MPOS system 106”). The information provided at “3” may include information associated with one or more merchants 102 that have been approved by the issuer 104 for merchant accounts pursuant to the present invention. The information may be provided in a batch file or other format and may include information identifying each approved merchant 102, the payment account information associated with each merchant (such as a direct deposit account number, a primary account number, or the like associated with the account just issued by the issuer 104 to the merchant 102), and any relevant merchant account limitations associated with the merchant account approved for the merchant.

The MPOS system 106, upon receipt of the information associated with approved merchants, creates a unique merchant identifier (“merchant ID”) for each merchant and updates an MPOS datastore to associate the merchant ID with information provided by the issuer 104 to create a mapping between the merchant ID and the merchant's bank account issued by issuer 104. The MPOS system 106 then causes a registration process to occur to associate the merchant ID and any merchant account limitations with a mobile payment application to be provided to the merchant 102. Pursuant to some embodiments, the mobile payment application may be a payment application provided by a third party service such as, for example, the Square® payment application offered by Square, Inc. In some embodiments, the payment application may be co-branded with the issuer 104 such that the payment application is branded as being provided or sponsored by the issuer 104. Pursuant to some embodiments, the payment application may be made available for download through one or more application providers, such as through the Apple iTunes Store® or the Google Android Marketplace®.

In some embodiments, the MPOS system 106 and/or the issuer 104 may provide one or more hardware plugins or “dongles” to the merchant for use with one or more mobile devices of the merchant. The hardware plugins or dongles may be used to convert one or more mobile devices (operating in conjunction with a payment application installed on the mobile device) to operate as a point of sale terminal The hardware plugins or dongles may be one or more of a magnetic stripe reader and/or a contact or contactless chip card reader, allowing a mobile device to read and process payment transactions involving magnetic stripe payment cards, and/or chip cards (either via contact or contactless communication). The hardware plugins or dongles may be provided with a wired or wireless connection allowing the plugin or dongle to be used with a mobile device.

Once the merchant ID and merchant account information has been associated with the merchant's bank account information at the MPOS system 106, the MPOS system 106 may provide a confirmation message (via an API or other method) to the issuer 104 (shown as message “4”). The confirmation message may include details of the merchant ID assigned by the MPOS system 106 as well as other configuration information associated with the merchant account. Further, the MPOS system 106 may cause a message “5” to be transmitted to the merchant, informing the merchant 102 that it has been approved for a merchant account and providing the merchant 102 with information and instructions to utilize the merchant account. In some embodiments, message “5” may be an email or other electronic message that provides a hyperlink allowing the merchant 102 to easily navigate to an issuer co-branded website to download and install the payment application on one or more mobile devices operated by the merchant 102 (e.g., such as a mobile telephone or tablet computer). Pursuant to some embodiments, the message “5” may also provide a user name and a temporary password for use by the merchant 102 in downloading and configuring the payment application to cause a mobile device to be used as a mobile POS terminal associated with the merchant's newly established merchant account. The message “5” may also provide instructions on installing, configuring and using a hardware device or dongle provided by the MPOS system 106, the issuer 104 or other entity.

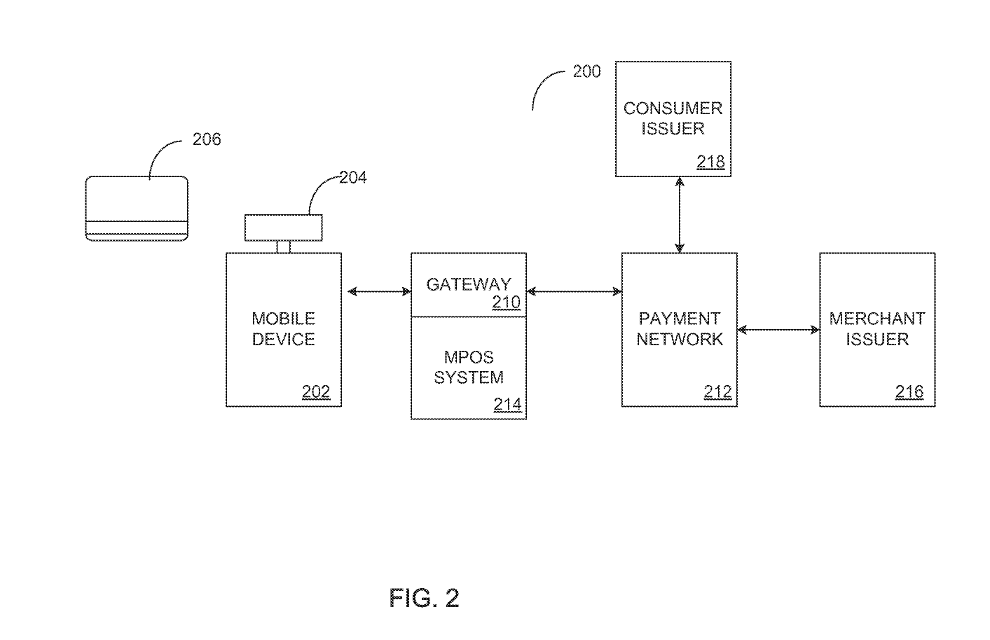

Once a merchant 102 has been approved for a payment account and a merchant account pursuant to the present invention, and has obtained and configured a hardware device or dongle and a payment application on at least one mobile device, the merchant 102 may accept payment card transactions using the mobile device. Reference is now made to FIG. 2 where a system 200 is shown illustrating devices and communication associated with processing and settling a purchase transaction at the merchant 102 pursuant to the present invention.

As shown in FIG. 2, a number of entities and devices are involved in a payment transaction at a merchant that has been issued a payment account and a merchant account pursuant to the present invention. For example, a customer of the merchant may present a payment card 206 at a mobile point of sale device operated by the merchant to complete a purchase transaction at the merchant. The mobile point of sale device includes a mobile device 202 (which may be a mobile telephone, a tablet computer, or the like, on which is installed a payment application pursuant to the present invention) and a hardware reader device 204. The reader device 204 may be a magnetic stripe reader or a chip card reader (either contact or contactless), and provides data from the payment card 206 to the mobile device 202 via a communications interface. In some embodiments, the reader device 204 may be a hybrid device which allows interaction with both magnetic stripe cards and chip cards.

The mobile device 202, under control of the payment application, transmits a transaction authorization request to a remote gateway 210. Transmission of the transaction authorization request to the gateway 210 is over a wireless communication interface. The wireless communication interface may be a wireless data connection or an internet connection and, in some embodiments, may be a secure connection. The transaction authorization request may include a merchant identifier (which was assigned to the merchant by the MPOS system 214 as described above), data read from the payment card 206 (such as the customer's primary account number, verification data such as a CVV/CVC code, an expiry date, and the like) and a transaction amount. In some embodiments, the gateway 210 and the MPOS system 214 may be implemented by the same entity and further may be integrated on the same server or server systems. In some embodiments, the gateway 210 is deployed as a separate device or system (or even operated by a separate entity) from the MPOS system 214.

The gateway 210, upon receiving the transaction authorization request, identifies the merchant ID and the transaction as involving a mobile point of sale device pursuant to the present invention, and determines that the acquirer for the transaction is the merchant issuer 216 (e.g., by querying a lookup table held at the MPOS system 214). The gateway 210, in conjunction with the MPOS system 214, may also determine whether any special processing limitations associated with the merchant or the merchant account should be applied. For example, when the merchant account was established for the merchant (as described above in conjunction with FIG. 1), the issuer 216 may have set processing limitations for transactions at the merchant. Such limitations may be enforced or applied at the MPOS system 214 during transaction processing. In some embodiments, the gateway 210 forwards the transaction authorization request to a payment network 212 to route the authorization request to the issuer 218 of the consumer's payment card for authorization processing. If the transaction is authorized (e.g., the account associated with the consumer's payment card has sufficient funds or credit for the transaction), an authorization approval response is returned to the gateway 210 for transmission to the mobile device 202 to complete the transaction.

Because the merchant account issuer 216 is both the acquirer of the payment transaction involving the consumer as well as the issuer of the merchant's payment account, settlement processing is performed using the MPOS system 214, and the MPOS system 214 prepares clearing and settlement files to ensure that funds are transferred from the issuer 218 of the consumer's payment card to the issuer 216. In some embodiments, the MPOS system 214 provides a settlement account for MPOS transactions maintained for each participating issuer 218. Further, in embodiments where the merchant payment card (issued by issuer 216) is the same payment card brand as the operator of the payment network 212 (e.g., the merchant payment card is a MasterCard debit card, and the payment network 212 is the MasterCard payment network), “payment to” authorization and clearing transactions may be used to credit funds to individual merchant payment accounts from consumer payment card accounts during authorization processing. In this manner, embodiments allow merchants to enjoy quick and accurate posting of funds from transactions involving the present invention.

While only a single consumer payment card, mobile device and other components are shown in FIGS. 1 and 2, those skilled in the art will appreciate that in use, a number of such components will likely be involved, allowing a number of merchants to accept payments from a number of consumers and involving a number of different issuers and payment networks. Further, while only a single gateway and MPOS system are shown, a number of such systems may be used.

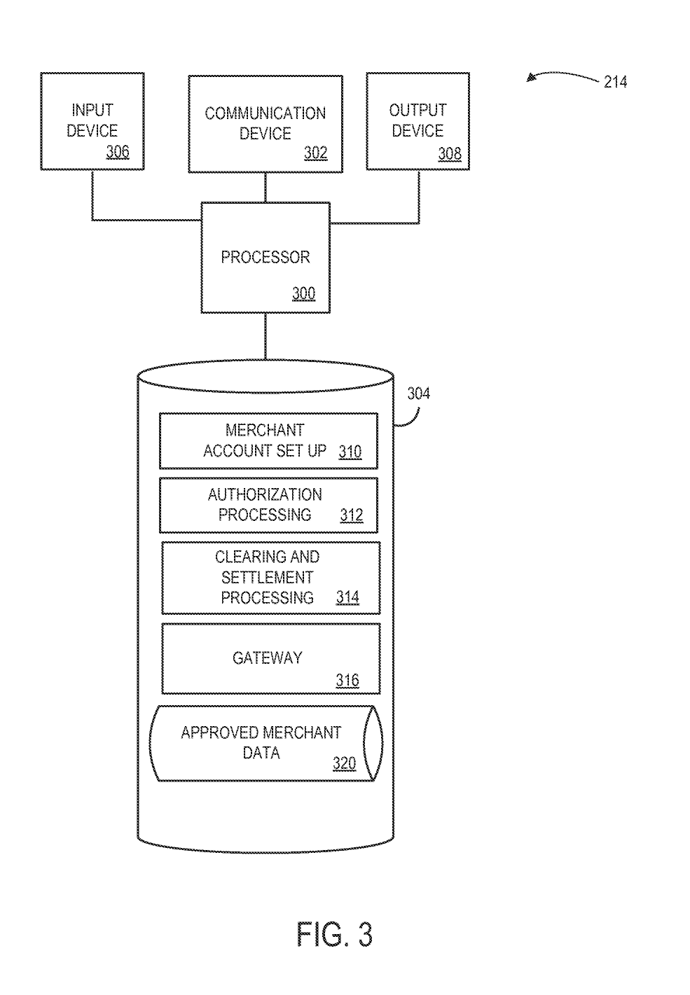

FIG. 3 is a block diagram that illustrates a MPOS system server computer 214. In its hardware aspects the MPOS system server computer 214 may be entirely conventional, but programmed to provide functionality as described herein.

As depicted, the MPOS system server computer 214 includes a computer processor 300 operatively coupled to a communication device 302, a storage device 304, an input device or devices 306 and an output device 308. Communication device 302 may be used to facilitate communication with, for example, other servers, terminals, remote mobile POS devices, or the like via one or more data communication networks (e.g., as shown in FIGS. 1 and 2). Continuing to refer to FIG. 3, the input device(s) 306 may comprise, for example, a keyboard, a keypad, a mouse or other pointing device, a microphone, knob or a switch, an infra-red (IR) port, a docking station, and/or a touch screen. The input device(s) 306 may be used, for example, to enter information. Output device 308 may comprise, for example, a display (e.g., a display screen), a speaker, and/or a printer.

Storage device 304 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

Storage device 304 stores one or more programs or portions of programs (at least some of which being indicated by blocks 310-318) for controlling processor 300. Processor 300 performs instructions of the programs, and thereby operates in accordance with the present invention. In some embodiments, the programs may include a program or program module 310 that programs the MPOS system server computer 214 to process files or batches of approved merchants received from one or more issuers.

Another program or program module stored on the storage device 304 is indicated at block 312 and is operative to allow the MPOS system server computer 214 to perform authorization processing of transactions involving mobile POS devices at registered merchant locations.

Still another program or program module stored on the storage device 304 is indicated at block 314. Program (or program module) 314 may program the MPOS system server computer 214 to perform clearing and settlement processing of transactions involving mobile POS devices at registered merchant locations.

A further program/program module 316 provides gateway functionality (allowing MPOS system server computer 214 to operate as a payment gateway, communicating with remote mobile POS devices to conduct transactions). Pursuant to some embodiments, the module 316 may be programmed to operate as a MasterCard Internet Gateway Service (“MIGS”), allowing transactions to be processed on the MasterCard payment network.

There may also be stored in the storage device 304 other software, such as one or more conventional operating systems, device drivers, communications software, database management software, etc.

Still further, various kinds of data needed for operation of the MPOS system server computer 214 may be stored in the storage device 304, including for example approved merchant data 320. The approved merchant data 320 may include data associated with merchants that have been approved by issuers to utilize mobile POS devices to access merchant accounts

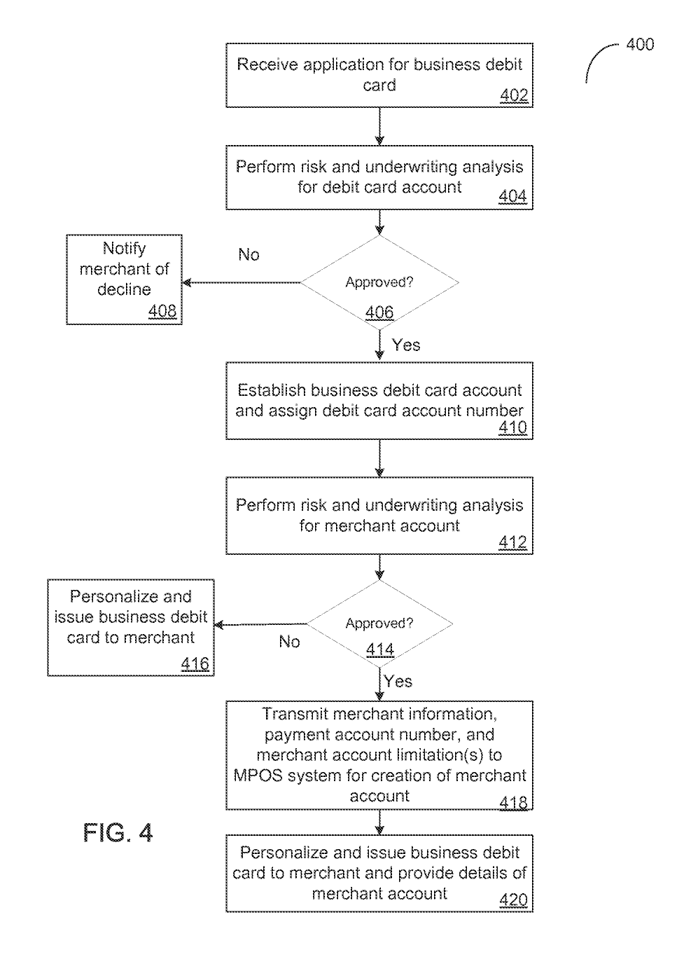

Reference is now made to FIG. 4 which depicts a process 400 for processing account applications in accordance with some embodiments. Pursuant to some embodiments, the process 400 may be performed by an issuer (such as the issuer 104 of FIG. 1) or an agent of issuer in response to a merchant's request for a business payment card. The process 400 will be described as being performed in response to a merchant's request for a small business debit card, however, those skilled in the art will appreciate that similar processing may be performed based on requests for other types of business payment card accounts (such as credit or charge card accounts). Process 400 may be initiated by a merchant by visiting a branch location of the issuer and requesting an account, or by visiting a Web page, interacting with an issuer representative over the phone, or the like.

Process 400 begins at 402 where the issuer receives an application for a business debit card. The application may be an application standardized by the issuer for collecting sufficient information about a merchant to perform the underwriting and risk analysis associated with issuing a business debit card account as well as associated with establishing a merchant account. The application may obtain, for example, contact information associated with the merchant, business information about the merchant (including retail sales numbers, sales locations, information associated with the types of goods and services sold by the merchant, and the like). The type of information obtained at 402 may depend on the merchant location and type of business.

Processing continues at 404 where the issuer performs risk and underwriting analysis associated with the establishment of a business debit card account. In some embodiments, the risk and underwriting analysis may result in requests for additional information from the merchant. In the event that the risk and underwriting analysis indicates that the merchant does not qualify for a business debit card account, processing continues at 408 where the merchant is informed of the decline.

In the event that the risk and underwriting analysis indicates that the merchant qualifies for a business debit card account, processing continues at 410 where a business debit card account is established, and an account number is assigned to the new account. The approval may also trigger other actions, such as a card personalization and fulfillment process (e.g., by which a business debit card is created, embossed, and personalized for the merchant and a mailer is generated to deliver the personalized debit card to the merchant).

Processing continues at 412 where the issuer performs further risk and underwriting analysis to determine if the merchant is also qualified for approval for a merchant account pursuant to the present invention. The risk and underwriting analysis performed at 412 may include the results of the risk and underwriting analysis performed at 404 and may be designed to not replicate risk and underwriting questions or analyses already performed, but may instead augment the risk and underwriting analysis to minimize fraud or other risk associated with providing a merchant account to the merchant. The risk and underwriting analysis performed at 412 may result in the generation of a decline or an approval, and the approval may be with limitations or conditions on usage of the merchant account (such as monthly or daily volume limitations, specific fees, chargeback limitations, or the like). If the merchant is declined, processing may continue at 416 where the merchant is only issued the business debit card approved at 410. Processing at 416 may include finalizing any personalization or fulfillment activities to ensure that the merchant receives and has use of the business debit card account established at 410.

If the risk and underwriting analysis at 412 indicates that the merchant is approved for a merchant account, processing continues at 418 where the merchant information, the payment account number and any merchant account usage limitation(s) are transmitted to the MPOS system for use in creating a merchant account for the merchant. In some embodiments, the merchant information may be transmitted in a batch file to the MPOS system (e.g., along with information associated with other approved merchants). In some embodiments, the information may be transmitted to the MPOS system via an API. The MPOS system, upon receipt of the merchant information, updates a database of approved merchant data (e.g., such as the database 320 of FIG. 3) with information received from the issuer. For example, the database of approved merchant data may be updated to include the merchant contact data, the newly-assigned debit card account number, and any merchant account limitation(s) that are to be applied to the merchant's usage of the merchant account. In some embodiments, the MPOS system assigns each approved merchant a unique merchant ID for use in transaction processing and clearing and settlement. The MPOS system may further generate an email or other notification to the merchant informing the merchant of their approval for a merchant account, as well as instructions for obtaining, installing and using a reader device and a mobile payment application for use with a mobile device.

Processing continues at 420 where the issuer finalizes the personalization and issuance of the business debit card to the merchant. The issuer may also provide details of the merchant account to the merchant (including any terms and conditions, restrictions on usage, and other information on obtaining, installing and using a reader device and mobile payment application for merchant processing).

The result is a system and method that allows small businesses and other merchants to efficiently obtain a business debit card (or other business payment card) as well as a merchant account. Embodiments provide an efficient application and approval process which reduces time and effort required to obtain a debit card and a merchant account, allowing a merchant to quickly be set up with the banking infrastructure to run a business.

Embodiments may be desirably be used with any of a number of different types of small businesses in different locations. As a specific example, applicants believe the present invention may be desirably be used in geographic locations such as those in the Asia Pacific region, where the underwriting and cost associated with establishing small business accounts can be quite substantial. Further, embodiments allow merchants to avoid the duplication of time and effort typically required when applying for a merchant account, as embodiments allow a single application process to result in the approval and issuance of both a business debit card and a merchant account.

Many first tier financial associations require submission of significant financial credentials from a small business to its bank to accompany the small business's application for a payment card. Later, if that same small business then seeks to obtain a merchant services account from the first tier association, an underwriting process might then require submission of these same financial credentials for approval to obtain the merchant services account. When a first tier association's member bank issues a debit and/ or credit card to a small business, that small business has likely provided enough data necessary to meet regulatory requirements and to meet the first tier association's requirements to underwrite the small business as a merchant. All the relevant data to generate a risk profile and evaluate the small business for a merchant services account is likely submitted to the small business's bank at the time the small business applied for its payment card.

An issuer bank (which can also function as an ISO—an independent sales organization) can perform a know-your-customer (KYC) analysis on the small business applicant by collecting the documents that an underwriter would review for risk evaluation. By including this service the issuer bank now has access to the merchant's receivables data and is now better positioned to cross sell cash management solutions to customers. Previously the issuer bank only had access to payments information.

A payments facilitator can provide a low cost, card reader that can be coupled to a multitude of platforms including mobile phones, tablet computers, personal computers, personal digital assistants, and the like. The card reader coupled to the platform can provide low volume merchants with a point-of-sale acceptance machine. The payments facilitator can provide the merchant with experience, build applications for card acceptance, and serve as a merchant interface for dispute management, reporting and customer service.

Combining an issuer bank that can perform risk analysis on a small business, a payment facilitator that can provide a card reader which couples to readily available communication platforms, and a payment network that can settle the fund transactions can enable very-small to small businesses to operate a merchant services account for accepting credit card payments. These very-small to small business can be in business categories (e.g., sole proprietorships, professional services, pass through corporations) that involve remote calls (doctors, exterminators, home cleaning services, etc.), mobile businesses (food trucks, charitable donation drives, etc.), start up businesses, home based businesses, and the like.

In accordance with an embodiment of the invention, a computer program application stored in storage device such as non-volatile memory or computer-readable medium (e.g., register memory, processor cache, RAM, ROM, hard drive, flash memory, CD ROM, magnetic media, etc.) may include code or executable instructions that when executed may instruct or cause a controller or processor to perform methods discussed herein such as a method for verifying a small business financial credentials, issuing a charge card, and creating a credit card merchant services account.

The computer-readable medium may be a non-transitory computer-readable media including all forms and types of memory and all computer-readable media except for a transitory, propagating signal. In one implementation, the non-volatile memory or computer-readable medium may be external memory.

Although specific hardware and data configurations have been described herein, note that any number of other configurations may be provided in accordance with embodiments of the invention. Thus, while there have been shown, described, and pointed out fundamental novel features of the invention as applied to several embodiments, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

1. A computer-implemented method comprising:
receiving, at an issuer/acquirer component under processor control, a prospective account holder payment card application and a set of financial credentials;
comparing, by an underwriting element of the issuer/acquirer component, the financial credentials to a predetermined standard for issuing a payment card;
receiving, at the issuer/acquirer component, an indication that the prospective account holder is applying for a merchant services account;
confirmin that the financial credentials meet one or more predetermined merchant services account standards;
if the financial credentials meet the predetermined standards for issuing the payment card, the issuer/acquirer component issuing the payment card to the prospective account holder; and
if the financial credentials meet the one or more standards set by the card association, then card association component creating the merchant services account for the prospective account holder.

2. The method of claim 1, further including linking the created merchant services account to a merchant card reader component by a payment facilitator component, where the merchant card reader component is capable of connection to a port located on a communication device.

3. The method of claim 2, wherein the merchant card reader component includes the capability to process card transactions on a mobile communication device.

4. The method of claim 1, further including designating a card service provider component as an underwriter of the created merchant services account for risk management and transaction processing.

5. The method of claim 4, wherein the card service provider component performs the steps of:
managing authorization routing of transactions posted on the merchant services account;
preparing a clearing report and a settlement report for the merchant services account; and
submitting at least the settlement report to the issuer/acquirer component for settlement.

6. A non-transitory computer readable medium having stored thereon instructions which when executed by a processor cause the processor to perform the method of:
receiving a prospective account holder payment card application and a set of financial credentials;
comparing the financial credentials to a predetermined standard for issuing a payment card;
receiving an indication that the prospective account holder is applying for a merchant services account;
confirming that the financial credentials meet one or more predetermined standards for creating a merchant services account;
if the financial credentials meet the predetermined standards for issuing the payment card, issuing the payment card to the prospective account holder; and
if the financial credentials meet the one or more standards for creating a merchant services account, then creating the merchant services account for the prospective account holder.

7. The computer readable medium of claim 6, further including executable instructions to cause the processor to perform the step of linking the created merchant services account to a merchant card reader component, where the merchant card reader component is capable of coupling with a communication device.

8. The computer readable medium of claim 6, further including executable instructions to cause a processor to perform the step of designating a card service provider component as an underwriter of the created merchant services account for risk management and transaction processing.

9. The computer readable medium of claim 6, further including executable instructions to cause a processor to perform the steps of:
managing authorization routing of transactions posted on the merchant services account;
preparing a clearing report and a settlement report for the merchant services account; and
submitting at least the settlement report to an issuer/acquirer component for settlement.

10. A system comprising:
a server including a control processor, the server connected to an electronic communication network;
an issuer/acquirer component under the control of a processor and connected to the electronic communication network, the issuer/acquirer component configured to receive a payment card application and an indication of application for a merchant services account;
the issuer/acquirer component including an underwriter element configured to compare financial credentials associated with the payment card application to predetermined standards for issuing a payment card;
a card association component connected to the electronic communication network, and including an evaluation element configured to confirm whether the financial credentials meet one or more predetermined merchant services account standards;

11. The system of claim 10, the issuer/acquirer component configured to issue a payment card if the financial credentials meet the predetermined standards for issuing the payment card.

12. The system of claim 10, the card association component configured to create a merchant services account if the financial credentials meet the one or more predetermined merchant services account standards.

13. The system of claim 10 further including a payment facilitator component configured to supply the merchant services account with a merchant card reader platform.

14. The system of claim 13, wherein the merchant card reader platform is a dongle configured to communicate with a mobile communication device.

15. The system of claim 10, further including a storage device connected to the processor, the storage device storing instructions configured to cause the processor to:
receive a prospective account holder payment card application and a set of financial credentials;
compare the financial credentials to a predetermined standard for issuing a payment card;
receive an indication that the prospective account holder is applying for a merchant services account;
confirm that the financial credentials meet one or more predetermined standards for creating a merchant services account;
if the financial credentials meet the predetermined standards for issuing the payment card, issue the payment card to the prospective account holder; and
if the financial credentials meet the one or more standards for creating a merchant services account, create the merchant services account for the prospective account holder.
